(19) United States
(12) Patent Application Publication
(10) Pub. No.: US 2002/0168014 A1
(43) Pub. Date: Nov. 14, 2002

(54) Communications with minimized propagation delay

(76) Inventors: James Patrick Dunn, Sandwich, IL (US); Gregory Charles Munie, Naperville, IL (US); John William Peterson, Lisle, IL (US)

Correspondence Address: Charles L. Warren, 28W525 Diversey Ave., West Chicago, IL, 60185, US

(21) Appl. No.: 10/082,720

(22) Filed: Feb. 26, 2002

Related U.S. Application Data
(60) Provisional application No. 60/288,977, filed on May 4, 2001.

(51) Int. Cl. H04L 27/00

(52) U.S. Cl. 375/259

(57) ABSTRACT

A method and system that reduces delays in communications by emitting particles/waves such as quons or photons that appear to traverse at least part of the path faster than the speed of light in a vacuum. While traveling faster than the speed of light in a vacuum, the information bearing photon/quon pulses are subjected to negative delays, that is, time gains. Slower particles may also be used to improve detect ability and security.

### TECHNICAL FIELD

The invention relates to methods and systems for communication links and more particularly to methods and systems for communication links having at least one stage that communicates via attributes that move faster than “c”, the speed of light in a vacuum.

### DESCRIPTION OF THE PRIOR ART

Some physicists are constantly experimenting in the regions near the edge of known physical science. One such region is where some classical Newtonian physical laws do not seem to apply. In such a region, some particles appear to travel faster than the speed of light in a vacuum.

For example, quantum theory and Schroedinger's wave equation hold that an electron surrounding the nucleus of an atom changes from one orbit (or one probability density) to another orbit of a different size and energy level, instantaneously. Such orbital changes are accompanied by the absorption or emission of one or more photons. Physicists have long noted that motions of electrons that occur instantaneously over at least part of their journeys appear to exceed the speed of light in a vacuum.

Experimenters J. WANG, A. KUZMICH and A. DOGARIU ofNEC Research Institute, Princeton, New Jersey investigated Gain-Assisted Superluminal Light Propagation and reported their results in Nature vol.406 pp. 277-279. Even though Einstein's theory of special relativity and the principle of causality imply that the motion of any moving object cannot exceed the speed of light in a vacuum “c”, by using gain-assisted linear anomalous dispersion superluminal light propagation in an atomic cesium gas cell such motion can be and has been demonstrated. The experimenters showed that a laser light pulse propagating through an atomic cesium vapor cell that was pumped by lasers to near absolute zero appeared at the exit side so much earlier than if it had propagated the same distance in a vacuum that the peak of the light pulse appeared to leave the cell before entering it. Thus moving faster than the speed of light in a vacuum. Experimenter, J. Wang explains in the above referenced publication that the light pulse traversed the atomic cesium vapor cell with a negative group velocity and also a negative propagation time.

Physicists David Wineland and Chris Monroe reported another experiment that provides an example of instantaneous action, in January 2000 in an article in Nature. They reported that they had successfully created an experiment using a beryllium atom in a half-millimeter electromagnetic trap. They exposed the trapped atom to laser beams in a precisely controlled way. As a result of this experiment, Wineland and Monroe were able to create the somewhat amazing condition of one atom being in two places at once for 100 microseconds. The clincher of this experiment was evidence that the two positions of the atom were interfering with each other. “If it [the trapped atom] was only one place exclusively, you wouldn't see any interference patterns,” Monroe said. The Wineland-Monroe experiment is one of the most definitive experimental validations of such instantaneous action. Another way of stating the result is that the beryllium atom moved from a first location to both a first and a second location. The only way the beryllium atom could be in two locations at the same time is for that atom to move between the two locations instantaneously.

Instantaneous travel from one location to another would be very desirable for communicating various types of data. Travel at greater than the-speed-of-light-in-a-vacuum is desirable for communication pulses. Negative propagation times for communication pulses would also be very desirable. Thus it is desirable to have a method and a system to communicate from one location to another location with minimum propagation delay, and ideally without a propagation delay.

### SUMMARY OF THE INVENTION

Briefly stated in accordance with one aspect of an embodiment of the invention the aforementioned shortcomings of communication systems are addressed and an improvement in the communication arts achieved by providing a method of communicating comprising the steps of creating from a signal, waves/particles at a source at a spaced relationship from a destination; detecting the waves/particles at the destination; and interpreting the effects of the waves/particles to provide a reconstruction of the signal for use at the destination. At the destination, the momentum of the waves/particles, at least one of which moved at least part of the way at speeds greater than the-speed-of-light-in-a-vacuum, is detected.

In another aspect of an embodiment of the invention, the aforementioned shortcomings in the art are addressed and an advance in the art achieved by providing: a translator that translates signals into waves/particles; an emitter that transmits the waves/particles from a source to a destination at a spaced relationship from the source location; a receiver that receives the waves/particles at the destination; a detector that detects the waves/particles at the destination, an interpreter at the destination that interprets effects of the waves/particles allowing a reconstruction of the signals for use at the destination. Momentum is carried from the source to the destination by the waves/particles emitted. This momentum communicates the translated signal from the source to the destination at a speed that is greater than the-speed-of-light-in-a-vacuum for at least part of the path.

### BRIEF DESCRIPTION OF THE DRAWINGS

An embodiment of the invention is shown in the drawings in which:

FIG. 1 is a diagram of a communication system according to the present invention;

FIG. 2 is a partially cut away diagram of a multiple wave/particle emitter;

FIG. 3 is a perspective diagram of a multiple wave/particle transmitter;

FIG. 4 is a partially cut away diagram of a multiple wave/particle receiver.

### DETAILED DESCRIPTION

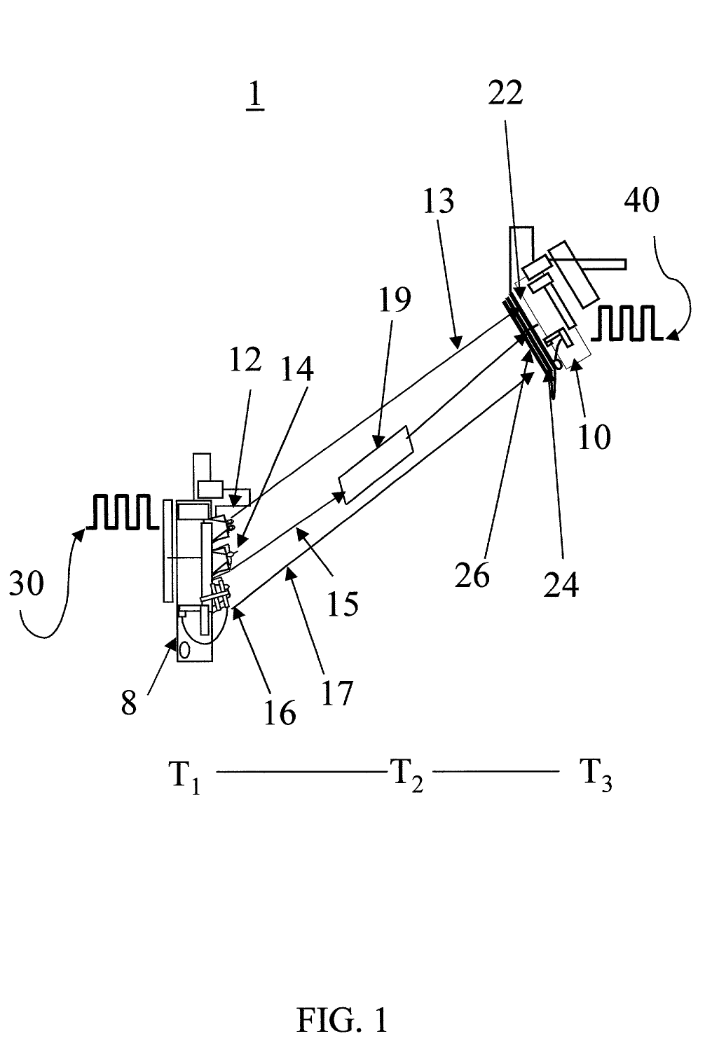

Referring now to FIG. 1, one embodiment of the present invention is shown. In FIG.1, a communications link system 1 is represented. System 1 preferably has an array of emitters 12, 14 and 16. At least one of these emitters is an emitter that has a negative time delay 19 over a portion of its total path. For each emitter 12, 14, 16 there is a corresponding detector 22, 24, 26. In operation a digital signal 30 at time T₁ is impressed upon emitters 12, 14, 16 and causes change in the waves/particles of each emitter 12, 14 and 16 at times T₂₁₂, T₂₁₄, and T₂₁₆. These changes effected on the waves/particles emitted are detected at detectors 22, 24 and 26, respectively at times T₃₁₂, T₃₁₄, and T₃₁₆. The emitters 12, 14 and 16 are accurately located and synchronized with respect to detectors 22, 24 and 26, respectively. Because the waves/particles move more or less a straight line, the emitters 12, 14, 16 should be accurately aimed to impact the detectors 22, 24, 26 at pre-arranged times. Since the detectors are essentially targets, accuracy of the aiming of emitters 12, 14, 16 reduces the size requirement of the detectors 22,24, 26. Pre-arranged timing, i.e. synchronization, is desired because there will be cosmic rays that randomly impact the detectors 22, 24, 26, so synchronization of transmission and detection of communication pulses reduces the quantity of cosmic ray noise from which the signal must be detected. For the emitters 12, 14 and 16 and the corresponding detectors 22, 24 and 26 T₂₁₂, T₂₁₄, and T₂₁₆ are made as close to a range of 250 milliseconds to zero seconds as practically possible. Within this range, the time delay is usually found to be acceptable by users. Greater delays, confuse and annoy users because they cannot discern the difference between a pause in speaking and a delay due to propagation delays. Zero delay is good from a carrier standpoint because that means no unused time delay is built-in to any carrier system.

The system 1 shown in FIG. 1 transmits the digital signal 30 from a source 8 to a destination 10. The dominant constraint to the transmission speed in system 1 is simply the processing times of supporting processors (one at the source and one at the destination where an interpretation into digital signal 40 is made). The system 1 is otherwise unconstrained, at least theoretically, by such attributes as the-speed-of-light-in-a-vacuum, queuing and to some extent propagation delays between at least one of the devices. At least one of the emitters 12, 14, 16 has an element or part of the path wherein the emitter wave/particle travels at greater than the speed of light in a vacuum, such as an atomic cesium vapor cell. The cell could be internal to any photon emitter (internal cell not shown) or it may be external as the cell 19. Atomic cesium vapor cells when properly conditioned by lasers have been shown to provide negative time delays.

The system 1 and its method of operation are roughly analogous to a media-less quantum telegraph system. The digitized signals 30 are represented by ON/OFF pulses of electrons 13, photons 15 or quons 17 from emitters 12, 14 and 16, respectfully. A “quon” is any entity no matter how immense that may or may not be phase entangled that exhibits both wave and particle aspects in a peculiar quantum manner. Electron emitter 12 may be an electron accelerator or a directional beta particle source, photon emitter 14 may be a laser, maser or x-ray tube depending on the frequency of photons desired and quon emitter 16 may be an atomic accelerator. These pulses are transmitted via air, free space and for the case of photons negative time delay cell(s) to detectors 22, 24 and 26 where detection of each pulses'momentum (i.e., apparent existence/presence or lack thereof) on a detection device occurs. Momentum for a wave/particle with rest mass is its relativistic mass times its velocity. Momentum for a photon that has no rest mass is equal to plank's constant times its frequency in cycles per second divided by divided by the-speed-of-light-in-a-vacuum.

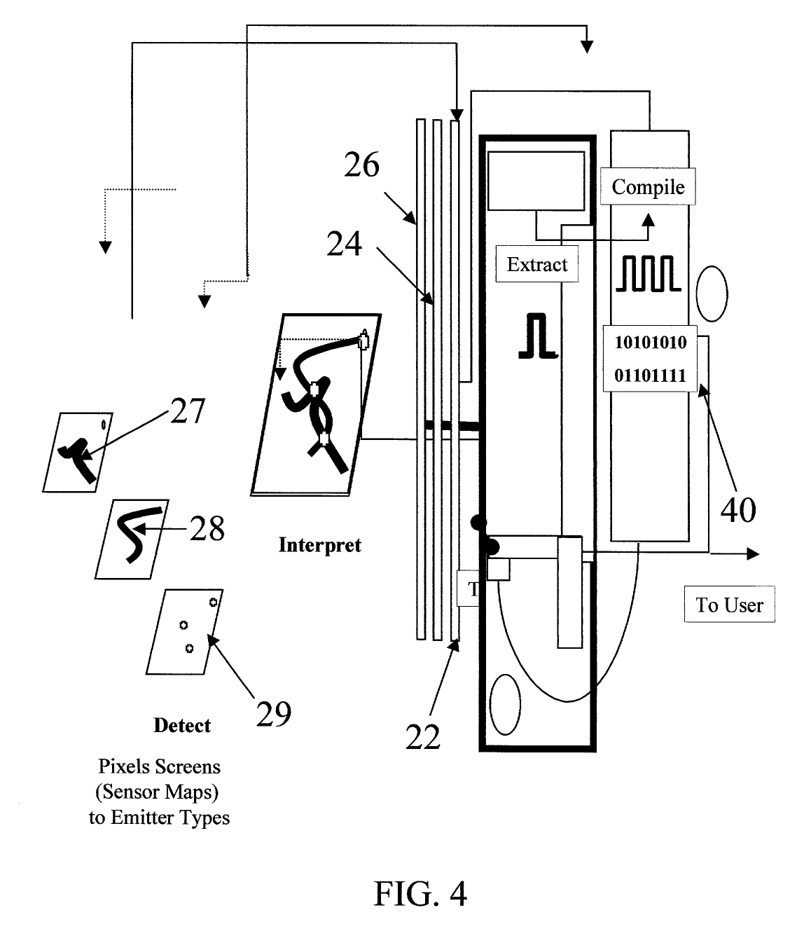

Random activity at each detector 22, 24 or 26 could be misconstrued, so multiple emitters 12, 14 and 16 are preferably used as well as synchronization. As mentioned above, the paths between emitters and detectors are approximately straight lines, so pre-arranged synchronization of transmission times to detectors 22, 24 or 26 is used. To further reduce the chances of random noises leading to false signal reception and interpretation, special patterns, such as patterns 27, 28 and 29 (shown in FIG. 4) may also be used such that signals not following anticipated patterns of the emitters are ignored. A correlation of all three patterns is required for a true signal interpretation. Security could include encryption and privileged access to the pre-arranged schedules and the patterns. Detection is preferably not based upon on the measurement of the internal properties, such as frequency, phase or polarization, of the waves/particles, rather detection is based on the momentum of the waves/particles or the lack thereof The term wave/particle comes from quantum mechanics and is used because of the dual nature of many atomic and sub-atomic particles that have the attributes of a wave as well as the attributes of a particle.

The method of operation of system 1 includes:

A Translation of digital signals 30 into physical properties of beams of waves/particles 13, 15, 17. Emitters 12,14, 16 preferably have a known spaced relationship relative to detectors 22, 24, and 26.

Synchronization between the source with emitters 12, 14, 16 and destination with detectors 22, 24, 26, such as pre-arranged schedules of when to check for valid messages. Synchronization may also include the encoding of a predetermined series of digital signals into activation sequences that are transmitted prior to the transmission of information desired to be communicated to the receiver. The transmission of the predetermined series of digital signals aids in establishing synchronization and serves as a “wake up” alert. Pre-arranged time windows for the emitters 12, 14, 16 to transmit waves/particles and corresponding windows for waves/particles to impact detectors 22, 24, 26 also enhance synchronization.

Excitation of the waves/particles, that carry the data from source to destination, includes techniques that stimulate release of electrons, photons and quons. For photons, gain-assisted linear anomalous dispersion superluminal light propagation cell 19 is located on part of the path from emitter 14 to detector 24 such that the emitted photons on average travel faster than the speed-of-light-in-a-vacuum over the path. The cell 19 has a transparent opening at an input end and also one at an output end. Inside the cell 19 is a specially conditioned Cesium atomic vapor that does not occur naturally. Specifically, natural Cesium can exist in sixteen possible quantum mechanical states. These quantum mechanical states are called hyperfine ground state magnetic sub-levels. Experiments have proven that almost all cesium atoms can be driven to only one of the sixteen possible quantum mechanical states. This state corresponds to an almost absolute zero degree temperature in the Kelvin scale (−273.15 degree C. and obviously not naturally occurring). This state is achieved via a technique named “optical pumping” using lasers. The cell itself is as long as the Cesium vapor can be held at the almost zero degree Kelvin state of operation. For greater negative delay time of digital pulses, more than one cell 19 may be used along the path between source and destination. The gain-assisted linear anomalous dispersion superluminal light propagation cell 19 is shown as external to the emitter 14, but it could also be internal to source 8, also.

A presence, sufficient to transfer momentum at the destination 10 must occur. Thus the spaced relationship between source 8 and destination 10 is important and should be accurately known. The path is preferably a straight line to reduce the power required and the size required of the destination.

Correlation of both a detection of at least one wave/particle at the position of the array of detectors 22, 24, 26 and a prearranged pattern on one of the detectors 22,24, or 26, or multiple patterns with one another at different times because of differences in propagation periods. Such correlation reduces the number of false alarms from cosmic or other stray waves/particles.

Next is an interpretation of the correlated waves/particles at the destination 10 to extract a digital output signal 40 that corresponds to digital input signal 30.

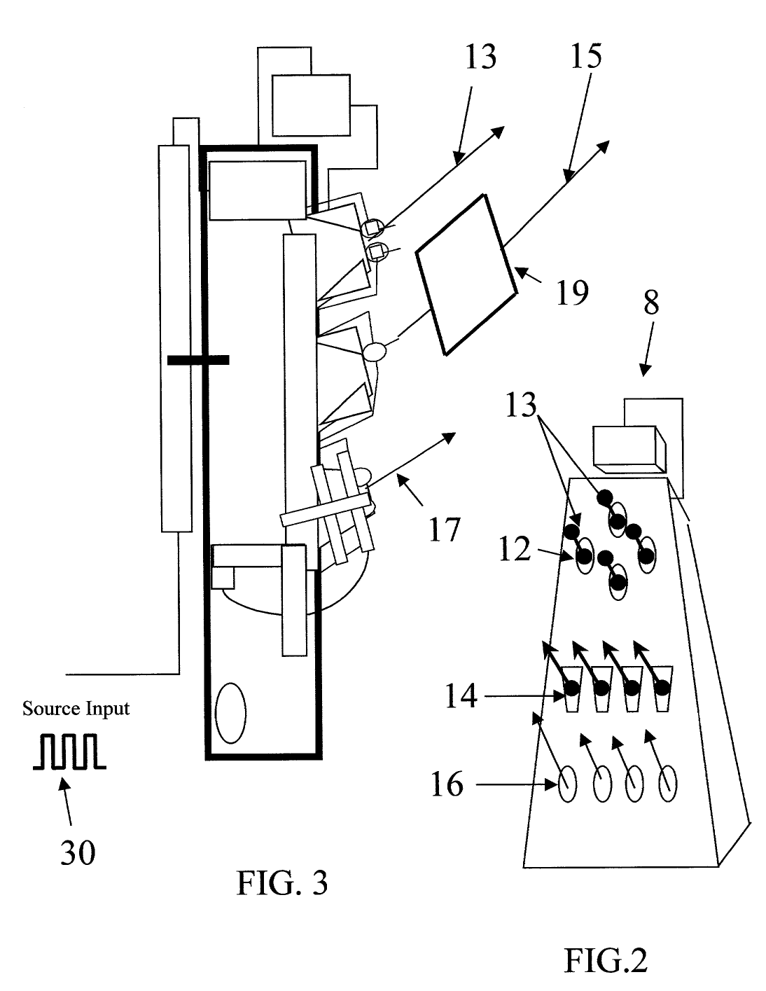

Referring now to FIGS. 2 and 3, an embodiment of the array of emitters 12, 14 and 16 is shown. The array of emitters 12, 14 and 16 emit three different types of waves/particles. Emitter array 12 has four electron emitters 13 for emitting electrons (also known as β particles in nuclear reactions). According to a preferred embodiment of the invention, the electrons are emitted at near the speed of light in a vacuum. These electrons are accurately directed to the remote electron detector 22. Emitter array 14 has four photon emitters for emitting electro-magnetic waves/particles 15 also known as photons. According to the embodiment shown in FIGS. 1 and 3 , photons 15 are emitted towards detector 24. Along the path to detector 24, the photons 15 go through a gain-assisted linear anomalous dispersion superlumenal light propagation cell 19 where it undergoes a negative time delay. After the negative time delay, the photons continue along the path to detector 24. Emitter array 16 has four quon emitters for emitting quon waves/particles towards detector 26. Quons encompass at least 100 known sub-atomic particles. The detector array 26 (see FIG. 4) can be another phosphorescent screen having a phosphor sensitive to the momentum of from the specific quon used, such as a proton, similar in operation to phosphorescent screens for electron and photon detection. Electron detectors 22 and photon detectors 24 are well known in the art. Three phosphorescent screens may be used overlaying each other as shown in FIG. 4.

As mentioned previously, photons from emitter 14 are directed through a cell 19 for gain-assisted linear anomalous dispersion superluminal light propagation that allows photons to be propagated at greater than the speed of light in a vacuum on its path to detector 24. So this particular path will take the least time. Electrons are subject more to deflections by magnetic fields and electric fields. Electrons also interact with other matter and are more readily absorbed in gases than photons. Quons have similar problems to electrons, and proton quons are larger than electrons so they have absorption problems also. Thus, electrons and quons are usable for short distances, controlled atmospheres, or outer space. There are presently no known negative delay cells for electrons or quons, so they will take longer to reach their respective detectors 22 and 26.

So for most locations and especially for terrestrial locations, photon emitters for emitters 12, 14 and 16 are preferred. Further, for greatest speed, each emitter 12, 14 and 16 would have a respective gain-assisted linear anomalous dispersion superluminal light propagation cell like cell 19. Depending on the amount of negative time delay provided by the negative delay cells, the propagation time from source 8 to receiver 10 can be reduced to almost zero. The negative time delay cells may extend over substantially the entire path or be distributed at different locations along the path from source to destination.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method of communicating comprising the steps of:
translating a signal into waves/particles;
emitting at least one stream of waves/particles from a source location to a receiving location at a
spaced relationship from said source location;
receiving said waves/particles at the receiving location;
detecting said waves/particles at the receiving location,
interpreting the effects of said waves/particles to provide a reconstruction of the digital signal for use at said receiving location;
the emitting causing the momentum of the waves/particles to travel from said source location to said receiving location at a speed that is greater than the speed of light in a vacuum over at least part of the path between emitting and receiving.

2. The method of claim 1, wherein said translating step includes encoding with a computer processor which encodes the digital signals into activation sequences.

3. The method of claim 1 wherein said emitting step includes exciting a bifurcated array of entopic time-synchronized exciters within said source location.

4. The method of claim 3 wherein said receiving step includes in said receiving location, a remote sensor array aligned with said bifurcated array of entopic time-synchronized exciters within said source location.

5. The method of claim 1 wherein said emitting is accomplished by one of the group: electron guns, photon emitters, and quantum wave/particle emitters.

6. The method of claim 3 wherein said emitting is accomplished by one of the group: electron guns, photon emitters, and quantum wave/particle emitters.

7. The method of claim 4 wherein said emitting is accomplished by one of the group: electron guns, photon emitters, and quantum wave/particle emitters.

8. The method of claim 7, wherein a number and a type of emitting are selected based upon established probability requirements for error detection and correction.

9. The method of claim 2, further comprising the step of determining a positioning and an alignment of said waves/particles by detection sensitivity, location of detection device, and processor enhanced alignment capabilities of the remote sensor array.

10. The method of claim 9 including the step of establishing a location in the detector by bit mapping to at least one excited pixel.

11. The method of claim 1, wherein the emitting step includes using a gain-assisted linear anomalous dispersion superluminal light propagation cell to reduce the delay between a terrestrial location and a synchronously orbiting location.

12. The method of claim 1, wherein the emitting step includes using a gain-assisted linear anomalous dispersion superluminal light propagation cell to reduce the delay between a terrestrial location and a location on another planet.

13. The method of claim 1, wherein the emitting step includes using a gain-assisted linear anomalous dispersion superluminal light propagation cell to reduce the delay between a terrestrial location and a location on a satellite.

14. An apparatus for communication, comprising:
a translator that translates signals into waves/particles;
an emitter that transmits said waves/particles from a source location to a destination location at a spaced relationship from said source location;
a receiver that receives said waves/particles at the destination location;
a detector that detects said waves/particles at the destination location, an interpreter at said destination location that interprets effects of said waves/particles allowing a reconstruction of said digital signals for use at said destination location; and
said transmission of the waves/particles from said source location to said destination location is by momentum of the waves/particles that traverse at least part of the path between emitter and receiver at a speed that is greater than the speed of light in a vacuum.

15. The apparatus of claim 14, further comprising a gain-assisted linear anomalous dispersion superluminal light propagation cell to reduce the delay between a terrestrial source location and a synchronously orbiting destination location.

16. The apparatus of claim 14, further comprising a gain-assisted linear anomalous dispersion superluminal light propagation cell to reduce the delay between a terrestrial source location and a destination location on another planet.

17. The apparatus of claim 14, further comprising a gain-assisted linear anomalous dispersion superluminal light propagation cell to reduce the delay between a terrestrial source location and a destination location on an earth orbiting satellite.
